(19) United States
(12) Patent Application Publication
(10) Pub. No.: US 2012/0313787 A1
(43) Pub. Date: Dec. 13, 2012

(54) Infant security system and method of use

(76) Inventors: Ines Moreno, Avon Park, FL (US); Javier Moreno, Avon Park, FL (US)

(21) Appl. No.: 13/157,567

(22) Filed: Jun. 10, 2011

(51) Int. Cl. G08B 23/00

(52) U.S. Cl. 340/573.4

(57) ABSTRACT

An infant security system comprising a pad, where the pad provides a surface upon which to rest an infant; a sensor within the pad, where the sensor detects when the infant is on the pad and where the sensor activates an alarm when the infant is lifted from the pad; an alarm receiver, where the alarm receiver is a remote device separate from the pad, where the alarm receiver receives a signal from the sensor after the sensor activates the alarm, and where the alarm receiver notifies a user that the infant has moved; and a keypad on the alarm receiver, where the keypad deactivates the alarm receiver after the user enters a deactivation code into the keypad. The alarm receiver may include a speaker that sounds and a light that flashes when the alarm is activated.

### BACKGROUND OF THE INVENTION

1. Field of the Invention

The present invention relates to a security device to notify a parent or guardian when their child or infant is moved or lifted from the location where they last left the child.

2. Description of Related Art

Parents and caretakers often have a difficult time constantly supervising their children and infants. With the demands of lifestyle and work the parent may become distracted drawing their attention elsewhere, away from the baby. These distractions may be harmful or potentially dangerous depending on the types of environmental factors faced by the baby when alone. If left alone a child may encounter objects or materials that are harmful if handled, placed in the mouth, or swallowed. Likewise, a distracted parent is left vulnerable to another person pestering or, in more disturbing circumstances, moving or taking their child.

Most of the time the parent or guardian knows the person moving the child and may consider the relocation annoying or bothersome. For example, when a new baby comes home the older siblings may want to continuously touch, move and hold the little one. This is often prohibited by the parent especially when the older siblings are not much older than the baby. The baby may be harmed if the sibling drops, dangerously handles or awkwardly repositions the baby.

Therefore, it would be beneficial in the art to provide a device that monitors when an infant is moved. It would also be desirable in the art to provide a device that activates an alarm when the infant is moved to notify the guardian of the movement.

### SUMMARY OF THE INVENTION

In view of the foregoing disadvantages inherent in the prior art, the general purpose of the present invention is to provide an infant security system, configured to include all of the advantages of the prior art, and to overcome the drawbacks inherent therein.

Accordingly, an object of the present invention is to provide a system that includes a baby pad that includes a sensor to determine when an infant is resting on the pad and when the infant is moved.

Another object of the present invention is to provide a system that notifies the user when the infant is moved from the pad.

To achieve the above objects, in an aspect of the present invention, an infant security system is disclosed comprising a pad, where the pad provides a surface upon which to rest an infant; a sensor within the pad, where the sensor detects when the infant is on the pad and where the sensor activates an alarm when the infant is lifted from the pad; an alarm receiver, where the alarm receiver is a remote device separate from the pad, where the alarm receiver receives a signal from the sensor after the sensor activates the alarm, and where the alarm receiver notifies a user that the infant has moved; and a keypad on the alarm receiver, where the keypad deactivates the alarm receiver after the user enters a deactivation code into the keypad. The alarm receiver may include a speaker that sounds and a light that flashes when the alarm is activated.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of an infant security system in accordance with an exemplary embodiment of the present invention.

FIG. 2 depicts an alarm receiver for the infant security system according to the present invention.

FIG. 3 depicts the infant security system according to the present invention placed in a crib.

### DETAILED DESCRIPTION OF THE DRAWINGS

The present invention relates to a security device to notify a parent or guardian when their child or infant is moved or lifted from the location where they last left the child. The present invention provides an infant security system consisting of a baby pad with an electronic sensor and an alarm receiver. During use the parent or guarding places their baby on the pad which activates the electronic sensor. If the child is moved the sensor activates the alarm receiver which either sounds a noise, flashes a light or both to alert the parent that the infant is not longer where they placed them. This way the parent is able to monitor their baby without always being next to the child. The infant security system prevents others from moving, lifting and taking the child, therefore keeping the baby safe from harm.

Tuning now descriptively to the drawings, referring to FIG. 1, a perspective view of an infant security system (10) is shown in accordance with an exemplary embodiment of the present invention. The infant security system (10) includes a pad (12) as a surface upon which to lay an infant. The pad (12) may be placed on a mattress within a crib or playpen. The pad (12) may include a layer of padding to provide greater comfort for the infant or child while resting on the pad (12). The pad (12) may have a square (as shown), circular or rectangular shape. The pad (12) may have a rubber base to ensure that it does not slide once the infant is placed upon the top surface. The top surface may be covered with a felt, cloth, or quilted material to provide greater comfort against the infant's skin. Around the peripheral portions of the pad (12) is an edge (14). The edge (14) may be angled sloping down to rest against the sides of the crib or playpen. Alternatively, the edge (14) may slope up creating a lip to ensure that the baby remains on the pad (12).

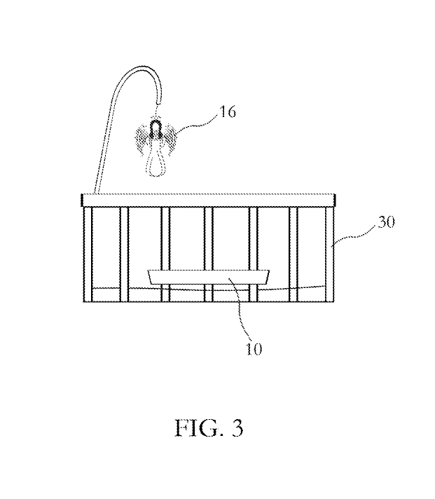

A guardian angel (16) may be placed above the pad (12) hanging above the crib or playpen, as shown in FIG. 3. The guardian angel (16) may be centered above the center portion of the pad (12). Decorating the corners of the pad (12) may be a series of angels (18). The series of angels (18) may be decorated playing a trumpet and may be placed in each corner of the pad (12).

Within the pad (12) may be an electronic weight sensor or motion sensor to detect when the infant is on the pad (12). The weight sensor may be positioned beneath the guardian angel (16). The weight sensor is activated when the infant is placed on the pad (12) and detects if the infant is lifted. The weight sensor monitors the weight of the infant and notices if a significant weight change is experienced. If the infant is moved or lifted from the pad (12), causing the significant weight change, an alarm is activated thereby creating a signal to alert the user that the infant is no longer on the pad (12). The weight sensor sends the signal to an alarm receiver (20), described further below. The weight sensor may be battery operated to ensure that there are no hanging cords or wires that may become choking hazards for the infant.

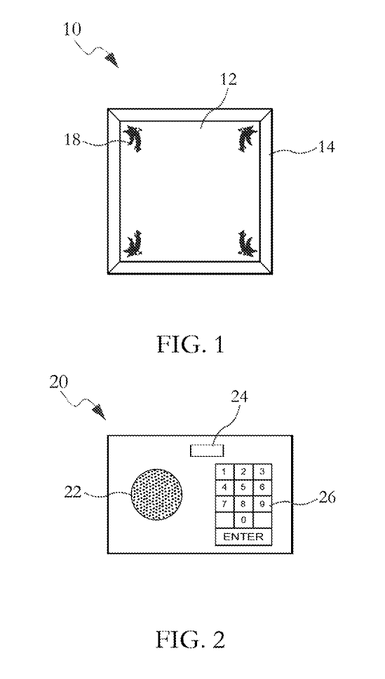

As an additional component of the infant security system (10) is the alarm receiver (20), as shown in FIG. 2. The alarm receiver (20) may be a remote device to be placed in a location of the user's choosing. The alarm receiver (20) may include a speaker (22) to sound a noise when the alarm is activated within the weight sensor. Additionally, the alarm receiver (20) may include a light (24) which may flash when the alarm is activated. The light (24) may be used along, and may prove more desirable for use if others in the house are napping or sounds would be inconvenient during use. Therefore, the alarm receiver (20) may include a switch to choose between the speaker (22), the light (24) or both to notify the user.

Once the alarm receiver is activated and the user is notified, either with the speaker (22) or the light (24), the user may turn off the alarm receiver (20) by entering a deactivation code into a keypad (26). The keypad (26) ensures that only the user is deactivating the alarm receiver (20). In this fashion, the user is sure to notice when the alarm is sounded, and the code ensures that a stranger cannot deactivate the alarm.

To use the infant security system, first the user places an infant on the pad. The weight sensor within the pad is then activated when it feels the weight of the infant. If the infant is lifted from the pad an alarm is activated. Upon activation, a signal from the weight sensor is sent to activate the alarm receiver. Once the alarm receiver receives the signal the alarm is activated within the receiver. The speaker may sound, the light may flash or both may operate to notify the user that the infant was moved. After notification the user may deactivate the alarm by entering the deactivation code into the keypad.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An infant security system comprising:
a pad, where said pad provides a surface upon which to rest an infant;
a sensor within said pad, where said sensor detects when said infant is on said pad and where said sensor activates an alarm when said infant is lifted from said pad;
an alarm receiver, where said alarm receiver is a remote device separate from said pad, where said alarm receiver receives a signal from said sensor after said sensor activates said alarm, and where said alarm receiver notifies a user that said infant has moved; and
a keypad on said alarm receiver, where said keypad deactivates said alarm receiver after said user enters a deactivation code into said keypad.

2. The infant security system according to claim 1, wherein said alarm receiver includes a speaker to create a sound when said alarm is activated.

3. The infant security system according to claim 2, wherein said alarm receiver includes a light that flashes when said alarm is activated.

4. The infant security system according to claim 3, wherein said alarm receiver includes a switch with three options to notify said user: 1. said speaker, 2. said light and 3. both said speaker and said light.

5. The infant security system according to claim 1, wherein said pad is placed within a crib.

6. The infant security system according to claim 1, wherein said pad is placed within a playpen.

7. The infant security system according to claim 1, wherein said pad includes an edge.

8. The infant security system according to claim 9, wherein said edge slopes up to create a lip around said infant.

9. The infant security system according to claim 1, wherein said sensor is battery operated

10. A method of use for an infant security system comprising the steps of:
placing an infant on a pad to activate a weight sensor within said pad;
notifying a user when said infant is lifted from said pad by said weight sensor sending a signal to an alarm receiver remote from said pad; and
deactivating said alarm receiver after notification.

11. The method of use for said infant security system according to claim 12, further comprising the step of sounding a speaker on said alarm receiver after said signal is received.

12. The method of use for said infant security system according to claim 12, further comprising the step of flashing a light on said alarm receiver after said signal is received.

13. The method of use for said infant security system according to claim 12, further comprising the step of entering a deactivation code to deactivate said alarm receiver.
